(19) United States
(12) Patent Application Publication
(10) Pub. No.: US 2004/0261959 A1
(43) Pub. Date: Dec. 30, 2004

(54) Beautiful window coverings

(76) Inventor: Sharly Jo Forcelli, Hopewell Junction, NY (US)

Correspondence Address: BEAUTIFUL WINDOW COVERINGS, 57 AUTUMN CHASE DRIVE, HOPEWELL JUNCTION, NY, 12533, US

(21) Appl. No.: 10/868,585

(22) Filed: Jun. 15, 2004

Related U.S. Application Data
(60) Provisional application No. 60/478,257, filed on Jun. 16, 2003.

(51) Int. Cl. E06B 9/24

(52) U.S. Cl. 160/368.1

(57) ABSTRACT

A custom window treatment made of fabric, that attaches to the top of a window's trim by use of hook and loop tape. The finished width and length of the window treatment matches that of the window for which it is intended. Primary ordering of the invention is via World Wide Web, although ordering and purchasing the invention may not be limited to this means.

### CROSS-REFERENCE TO RELATED APPLICATIONS

This application claims benefit of the following co-pending Provisional Patent Application: U.S. Provisional Patent Application No. 60/478,257 filed Jun. 16, 2003.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

This invention relates to custom, fabric, decorative window treatments that can be purchased via the World Wide Web and can be received in five days. This invention of decorative window treatments (or shades, or valances as they may also be known as), also relates to the manner in which they are fabricated, which is done without sewing of any kind, but instead uses a double sided adhesive in finishing the edges of the window treatments. This invention also relates to the manner in which the window treatments are attached to the window that they have been created for. This means is by hook and loop fastener strips that attach the window treatment directly to the top of the window's trim. This means of attachment to the window requires no rod system, no brackets, no tools, and leaves no holes in the window frame or the surrounding wall.

2. Description of the Prior Art

Current processes of custom making fabric decorative window treatments are lengthy ones. One common process requires hiring an interior designer or decorator to choose fabrics, and/or measure for the window treatments and/or install them after they have been fabricated. One can order custom decorative window treatments from various catalogs, but this process still requires at least three weeks (usually it is much longer) for their fabrication, and a person skilled in the usage of tools for their installation. Both processes are very lengthy and unfortunately, very expensive.

The process of ordering custom, fabric decorative window treatments that are available from the World Wide Web at www.bwcandinteriors.com/index2.html, is extremely beneficial to our society in that; they are easily affordable, they arrive within five days of ordering, they may be installed by anyone as there are no tools required to install them, they cause no damage to window frames or walls, and they can be removed just as easily as they are installed. This product allows people of all economic backgrounds to purchase a high-end (they are made of grade A silk) window treatment. This process of making custom, fabric, decorative window treatments that can be purchased from an online store (www.bwcandinteriors.com/index2.html) and received in five days, has proven to be very successful and very useful, and it appears to be the first of its kind. A few patents (which follow) have been filed that use hook and loop attachment strips, but all require; additional mounting pieces such as boards (that require the usage of tools and leave holes in walls), poles or telescoping curtain rods, or all of the aforementioned.

U.S. Pat. No. 5,074,348 discloses the usage of hook and loop attachment strips, as well as boards and poles that need to be mounted. Individual or combined swags and/or jabots that have hook and loop tape included in their fabrication, may be attached to the top of the board that has been mounted. Additionally, poles that contain hook and loop attachment strips may be dressed with swags that have been fabricated specially for these poles. Various designs in both board and pole choices are available.

U.S. Pat. No. 5,673,741 discloses a telescoping rod system that uses hook and loop attachment strips on both the swags and the curtain rods. Again, this system requires a rod and the knowledge of its installation.

U.S. Pat. No. 6,192,962 discloses a system that uses hook and loop attachment strips to hang several window treatments from an adjustable telescoping support bar. Although hook and loop tape is used as a means of attaching window treatments together, this idea also requires a rod system and the knowledge of its installation.

### BRIEF SUMMARY OF THE INVENTION

Custom made, fabric window treatments that can be ordered by anyone with no special knowledge or skill needed to understand window treatments or their installation, are available via the World Wide Web at http://www.bwcandinteriors.com/index2.html, and can be received in five days. These luxurious (made from grade A silk) window treatments are fabricated specifically to fit the customer's window, and attach to the top of the window's trim by hook and loop attachments strips. They are extremely easy to order, and are very inexpensive compared to all other traditional means of ordering and purchasing custom made fabric window treatments. They are also easily installed and removed, and do not require the use of tools or leave holes in the window's frame or the surrounding wall.

### BRIEF DESCRIPTION OF THE DRAWINGS

FIG. 1 is a view of the invention during manufacturing, whereas the sides and bottom of the piece of fabric are being secured with the double sided tape.

FIG. 2 is a view of the backside of a Beautiful Window Covering™ shade, with the attached strip of loop fabric at the top edge of the shade.

FIG. 3 is a top view of a window frame, with an attached strip of hook tape placed onto the top ledge of the frame's trim.

FIG. 4 is a front face view of a Beautiful Window Covering™ shade attached to a window frame.

FIG. 5 is a front face view of a Beautiful Window Covering™ shade attached to a window, and raised.

FIG. 6 is a close up view of one of the metal fabric clips that come with the invention.

FIG. 7 is a close up view of one of the metal fabric clips while it is holding up the gathered fabric of the invention, which is not visible while the shade is up.

### DETAILED DESCRIPTION OF THE INVENTION

Prior to the existence of the present invention, the process of acquiring custom, fabric window treatments was costly and time consuming. Only those who could afford it were required to wait through the following procedure of; 1) finding a decorator or designer to select fabrics, styles and take measurements, 2) waiting a minimum of six to eight weeks while the window treatments were fabricated, 3) paying double of what the actual product and complete service cost (shipping, professional installer, etc.) and 4) acquiring a semi permanent fixture in one's home that is difficult to remove and definitely leaves holes in walls and/or the window's trim.

Prior to the present invention, custom, fabric window treatments were not economically feasible for a large percentage of our population. Those of limited incomes whose list might include people of all backgrounds and situations, are now easily able to afford window treatments. Because the invention is made of high grade silk, the simple structure of the present invention will add beauty and elegance to anyone's home.

Prior to the present invention, custom, fabric window treatments were manufactured in a way that contributed somewhat to their cost. Prior examples required the necessity of a seamstress and/or sewing machine that worked either manually or automatically. The present invention is fabricated without sewing of any kind, only using double sided tape as a means of securing the edges. This means is not only faster than that of a sewing machine, it also leaves the edges tightly secured without the worry of fraying, as silk fabric has a tendency to do. This means also leaves the edges of the shades uniformly flat which is far more attractive than if sewing had been used, as silk is a very thin fabric.

Ordering Beautiful Window Coverings™.

Ordering the invention is quite simple and takes less than five minutes. From the World Wide Web, enter the URL http://www.bwcandinteriors.com/index2.html and arrive at the site of Beautiful Window Coverings™. As instructed, print the page and follow the rest of the instructions for ordering a shade that will fit the intended window. This is done by simply entering; 1) the width of the window including trim to the nearest inch, 2) the length of the window including trim to the nearest inch and adding two inches, and the 3) color choice of the fabric desired. The rest of the ordering requires payment information (which can be done with or without a credit card) and shipping information. The present invention will then be received by the customer within five days. If the shade was not manufactured exactly as the customer ordered, as per the order form, the customer may return the product and receive a shade that is exactly what was ordered. The return shipment is paid as well, by an electronic UPS label that the customer receives via email.

Manufacturing Beautiful Window Coverings™.

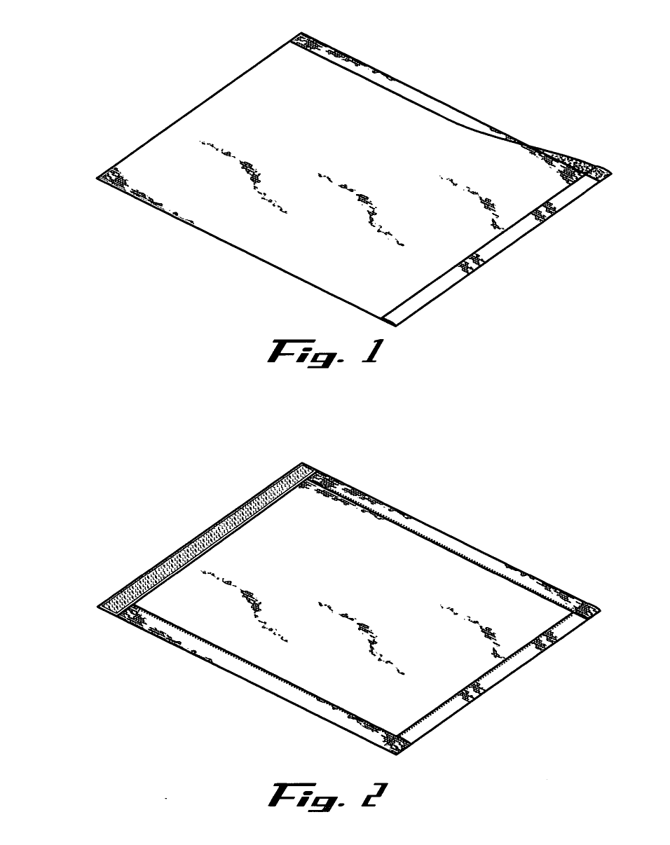

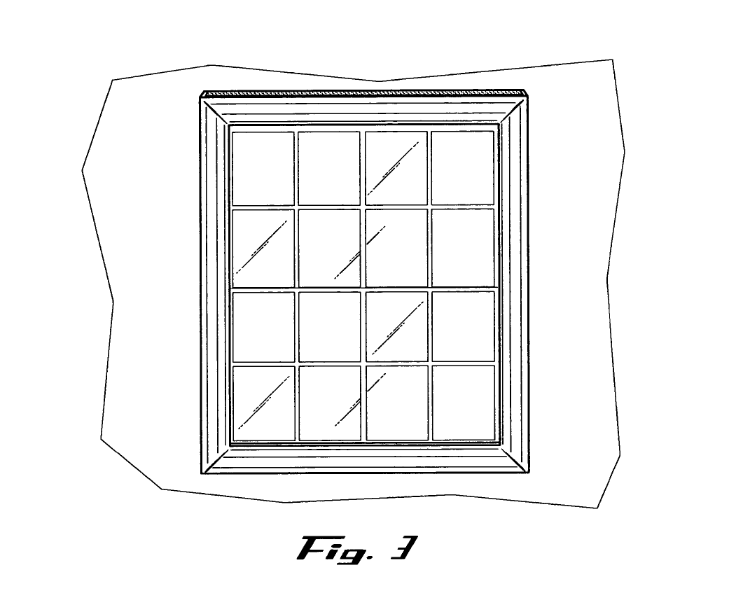

The product is manufactured in a way that is cost efficient and time saving, thus contributing to the low cost of the item. Once the order has been placed by the customer, the order is forwarded to the manufacturer to be constructed. This is done by cutting out a piece of fabric whose width is that of the width on the order form plus 1 inch, and whose length is that of the length on the order form plus two inches. A one-half inch strip of double sided tape is attached flush to the edges of both the right and left sides of the piece of fabric. This side that contains the double sided tape is now considered the back of the shade. The edges of the fabric are then folded inward (only one-half inch) so that the fabric attaches to itself and is left with a finished edge. See FIG. 1. A one-half inch strip of double sided tape is then attached to the bottom of the piece of the fabric, flush with the edge. This bottom edge is then folded upward (only one-half inch) so that it attaches to itself and is also left with a finished edge. A piece of loop tape that contains a removable adhesive backing is cut to a length that matches the width on the order form. The backing is removed and it is attached flush to the top edge of the piece of fabric. The shade is now complete. See FIG. 2. Included with the shade in its packaging are also the fabric clips for raising the shade, the strip of hook tape that is the same width as the shade, and the instructions for installing the shade.

Shipping of Beautiful Window Coverings™.

After the shade has been manufactured, it is then shipped to the customer via UPS 3-Day Select. The present invention, including all components and instructions, is sealed in clear poly-tubing and shipped in a sturdy cardboard box that measures 5×5×37. The customer receives two confirmations of their order; one prior-shipment confirmation and one post-shipment confirmation. The prior-shipment confirmation is from Paypal to let them know that a purchase has been made to Beautiful Window Coverings, Inc. The Paypal confirmation also gives the specifics of the order. The post-shipment confirmation is from UPS to let them know that their order has been shipped, that their order has been sent via UPS 3-Day Select, and that may use the tracking link given to inquire about their shipment.

Installing a Beautiful Window Coverings™ Shade.

Upon receiving the present invention, the customer may install and keep the shade, or, if the shade has not been manufactured to the customer's specifics on the order form, the shade may be returned. If the customer realizes that the shade is true to what was ordered, it is installed by the following steps which are on the instructions included in the package:

1. The backing is peeled off of the solitary piece of hook tape and is attached to the top of the window's trim. See FIG. 3.

2. The backside of the present invention is ironed with a warm steam iron to remove any wrinkles.

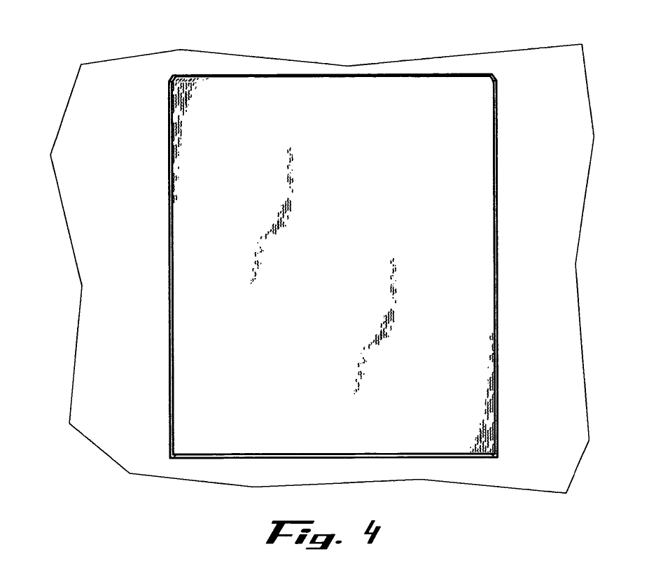

3. The shade is aligned with the window, and the strip of loop tape on the backside of the shade is attached directly to the strip of hook tape on the top of the window's trim so that the beginning and end of both hook and loop strip are the same, allowing the face of the shade to hang in front of the window. See FIG. 4.

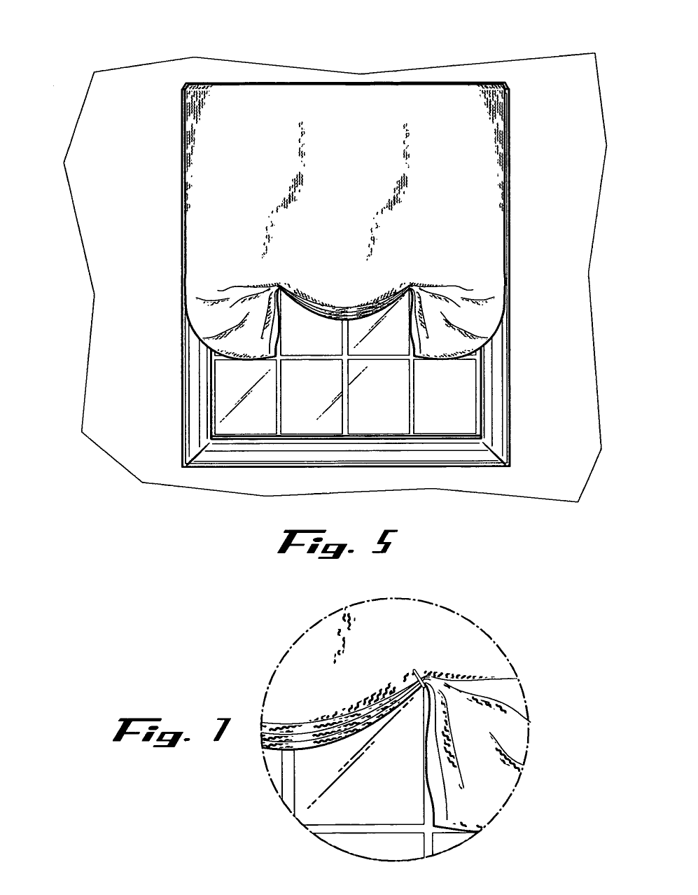

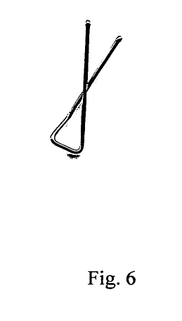

4. If it is desired to raise the shade, the fabric is gathered up until the desired height is achieved, and is then held in place (see FIG. 7) with the two fabric clips (see FIG. 6) to create a swag appearance of the middle section of gathered fabric. See FIG. 5. The fabric clips are so small and hold the fabric so tightly, that they are not visible while the shade is up.

How to Return a Beautiful Window Coverings™Shade.

If the shade received is not what was ordered according to the specifics of the order form, the customer may request a return, for which a UPS return label is sent via email and can be printed from the customer's computer. The return shipping is free to the customer as well as the new shade that is manufactured and sent again to the customer. Happy customers are the goal of Beautiful Window Coverings, Inc.!

What I claim as my invention is:

1. A fabric window treatment created to hang from the top of a window's trim with the use of hook and loop attachment strips, whereas the trim is defined as the “frame”, usually made of wood or metal around the window cut-out in the sheet rock or other wall material, whose depth (the distance from the wall itself to the front face of the trim) is usually or at least ½ inch.

2. The fabric window treatment of claim 1 wherein the included fabric clips are used to raise the window treatment to the desired height.

3. The fabric window treatment of claim 1 wherein the window treatment can be ordered and/or purchased from the World Wide Web.
